(19) United States
(12) Patent Application Publication
(10) Pub. No.: US 2022/0156599 A1
(43) Pub. Date: May 19, 2022

(54) GENERATING HYPOTHESIS CANDIDATES ASSOCIATED WITH AN INCOMPLETE KNOWLEDGE GRAPH

(71) Applicant: Accenture Global Solutions Limited, Dublin (IE)

(72) Inventors: Sumit PAI, Dublin (IE); Luca COSTABELLO, Newbridge (IE)

(21) Appl. No.: 16/952,941

(22) Filed: Nov. 19, 2020

(51) Int. Cl. G06N 5/02; G06N 5/04; G06N 20/00; G06K 9/62

(52) U.S. Cl. CPC G06N 5/022; G06N 5/04; G06K 9/6215; G06K 9/6239; G06K 9/6256; G06N 20/00

(57) ABSTRACT

A hypothesis generation system may determine sets of link types that are respectively associated with a plurality of nodes included in an incomplete knowledge graph to determine a plurality of intersection-over-union scores. The hypothesis generation system may determine, based on a plurality of vectors of an embedding space representation associated with the incomplete knowledge graph, a plurality of similarity scores and may determine, based on the plurality of intersection-over-union scores and the plurality of similarity scores, a plurality of affinity scores. The hypothesis generation system may determine, based on the plurality of affinity scores and the plurality of nodes, one or more node pairs; may generate, for a node pair, of the one or more node pairs, one or more triplet hypothesis candidate templates; and may generate, for a triplet hypothesis candidate template, of the one or more triplet hypothesis candidate templates, a plurality of triplet hypothesis candidates.

### BACKGROUND

A knowledge graph may be used to represent, name, and/or define a particular category, property, or relation between classes, topics, data, and/or entities of a domain. A knowledge graph may include nodes that represent the classes, topics, data, and/or entities of a domain and links connecting the nodes that represent a relationship between the classes, topics, data, and/or entities of the domain. Knowledge graphs may be used in classification systems, machine learning, computing, and/or the like.

### SUMMARY

In some implementations, a method includes obtaining an incomplete knowledge graph, wherein the incomplete knowledge graph includes a plurality of nodes and a plurality of links, wherein each link, of the plurality of links, is associated with a link type and connects two different nodes of the plurality of nodes; determining sets of link types that are respectively associated with the plurality of nodes; identifying a first node and a second node of the plurality of nodes; determining a common set of link types that includes link types shared by a set of link types associated with the first node and a set of link types associated with the second node; determining an overall set of link types that includes link types of the set of link types associated with the first node and the set of link types associated with the second node; determining an intersection-over-union score based on the common set of link types and the overall set of link types; populating, with the intersection-over-union score, an entry of an intersection-over-union matrix that is associated with the first node and the second node; generating, based on the incomplete knowledge graph, an embedding space representation that includes a plurality of vectors, wherein the plurality of vectors are respectively associated with the plurality of nodes; generating, based on the plurality of vectors of the embedding space representation, a similarity matrix; generating, based on the intersection-over-union matrix and the similarity matrix, an affinity matrix; identifying, based on the affinity matrix and the plurality of nodes, one or more node pairs; generating, for a node of the plurality of nodes that is associated with the one or more node pairs, one or more triplet hypothesis candidate templates; generating a plurality of hypothesis nodes based on the incomplete knowledge graph; generating a plurality of triplet hypothesis candidates based on the one or more triplet hypothesis candidate templates and the plurality of hypothesis nodes; selecting, based on respective potential existence scores associated with the plurality of triplet hypothesis candidates, one or more triplet hypothesis candidates from the plurality of triplet hypothesis candidates; and causing, based on the one or more triplet hypothesis candidates, one or more actions to be performed.

In some implementations, a device includes one or more memories and one or more processors, communicatively coupled to the one or more memories, configured to: identify a plurality of nodes and a plurality of links included in an incomplete knowledge graph, determine sets of link types that are respectively associated with the plurality of nodes; determine, based on the sets of link types, a plurality of intersection-over-union scores; generate an embedding space representation associated with the incomplete knowledge graph that includes a plurality of vectors associated with the plurality of nodes, determine, based on the plurality of vectors of the embedding space representation, a plurality of similarity scores; determine, based on the plurality of intersection-over-union scores and the plurality of similarity scores, a plurality of affinity scores; identify, based on the plurality of affinity scores and the plurality of nodes, one or more node pairs; generate, for a node pair, of the one or more node pairs, one or more triplet hypothesis candidate templates; generate, for a triplet hypothesis candidate template, of the one or more triplet hypothesis candidate templates, a plurality of triplet hypothesis candidates; identify, based on respective potential existences scores associated with the plurality of triplet hypothesis candidates, one or more triplet hypothesis candidates; and cause, based on the one or more triplet hypothesis candidates, one or more actions to be performed.

In some implementations, a non-transitory computer-readable medium storing a set of instructions includes one or more instructions that, when executed by one or more processors of a device, cause the device to: determine sets of link types that are respectively associated with a plurality of nodes included in an incomplete knowledge graph; determine, based on the sets of link types, a plurality of intersection-over-union scores; determine, based on a plurality of vectors of an embedding space representation associated with the incomplete knowledge graph, a plurality of similarity scores; determine, based on the plurality of intersection-over-union scores and the plurality of similarity scores, a plurality of affinity scores; determine, based on the plurality of affinity scores and the plurality of nodes, one or more node pairs; generate, for a node pair, of the one or more node pairs, one or more triplet hypothesis candidate templates; generate, for a triplet hypothesis candidate template, of the one or more triplet hypothesis candidate templates, a plurality of triplet hypothesis candidates; and cause, based on the plurality of triplet hypothesis candidates, one or more actions to be performed.

### BRIEF DESCRIPTION OF THE DRAWINGS

FIGS. 1A-1B are diagrams of an example knowledge graph schema and an example portion of a knowledge graph.

FIGS. 2A-2F are diagrams of an example implementation described herein.

FIG. 3 is a diagram of an example environment in which systems and/or methods described herein may be implemented.

FIG. 4 is a diagram of example components of one or more devices of FIG. 2.

FIGS. 5A-5B depict a flowchart of an example process relating to generating triplet hypothesis candidates associated with an incomplete knowledge graph.

### DETAILED DESCRIPTION

The following detailed description of example implementations refers to the accompanying drawings. The same reference numbers in different drawings may identify the same or similar elements.

A knowledge graph may include a plurality of nodes and a plurality of links, wherein a link is a directed link that connects a subject node to an object node. The link may have a link type that indicates a relationship between the subject node and the object node. In many cases, the knowledge graph may be automatically generated by a computing device (e.g., based on the computing device processing disparate sets of information). Consequently, the knowledge graph may be incomplete, such that the knowledge graph is missing links between nodes.

Machine learning models, such as a relational learning machine learning models, can be used to evaluate triplet hypothesis candidates to attempt to identify missing links of the knowledge graph. A triplet hypothesis candidate may identify a subject node, and object node, and a link type identifier for a potentially missing link. However, conventional techniques for generating triplet hypothesis candidates require extensive use of computing resources (e.g., processing resources, memory resources, and/or power resources, among other examples). Moreover, these conventional techniques often produce large numbers of triplet hypothesis candidates that have a low likelihood of being correct (e.g., a low likelihood that the machine learning models will determine that the triplet hypothesis candidates are associated with missing links of the knowledge graph), thereby wasting computing resources to generate and evaluate low quality triplet hypothesis candidates.

Some implementations described herein provide a hypothesis generation system that generates triplet hypothesis candidates associated with an incomplete knowledge graph. The hypothesis generation system may determine sets of link types that are respectively associated with a plurality of nodes included in the incomplete knowledge graph and may determine, based on the sets of link types, a plurality of intersection-over-union scores. The hypothesis generation system may determine, based on a plurality of vectors of an embedding space representation associated with the incomplete knowledge graph, a plurality of similarity scores and may determine, based on the plurality of intersection-over-union scores and the plurality of similarity scores, a plurality of affinity scores. The hypothesis generation system may determine, based on the plurality of affinity scores and the plurality of nodes, one or more node pairs and may generate, for a node pair, of the one or more node pairs, one or more triplet hypothesis candidate templates. The hypothesis generation system may generate, for a triplet hypothesis candidate template, of the one or more triplet hypothesis candidate templates, a plurality of triplet hypothesis candidates and may identify, based on respective potential existences scores associated with the plurality of triplet hypothesis candidates, one or more triplet hypothesis candidates. The hypothesis generation system may cause, based on the one or more triplet hypothesis candidates, one or more actions to be performed, such as updating the incomplete knowledge graph or a machine learning model (e.g., of the machine learning models described above).

In this way, the hypothesis generation system provides one or more triplet hypothesis candidates that have a high likelihood of being correct (e.g., a high likelihood that the machine learning models, described above, will determine that the one or more triplet hypothesis candidates are associated with missing links of the knowledge graph), thereby reducing use of computing resources (e.g., processing resources, memory resources, and/or power resources, among other examples) to produce and evaluate low quality triplet hypothesis candidates. Furthermore, by calculating the plurality of intersection-over-union scores, the similarity scores, and the affinity scores to facilitate identifying node pairs with at least one node that is likely associated with a missing link, the hypothesis generation system reduces use of computing resources to generate triplet hypothesis candidates for nodes unlikely to be associated with a missing link. Moreover, by generating triplet hypothesis candidates based on triplet hypothesis candidate templates, the hypothesis generation system reduces use of computing resources to generate triplet hypothesis candidates associated with link types that are unlikely to be associated with a missing link. Accordingly, the hypothesis generation system conserves computing resources for generating triplet hypothesis candidates, as compared to conventional processing techniques.

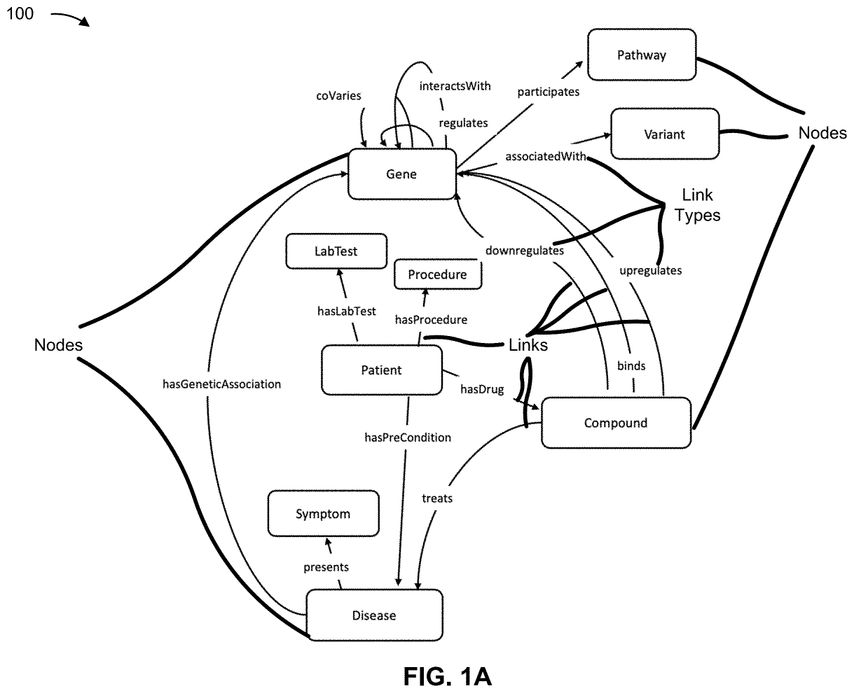

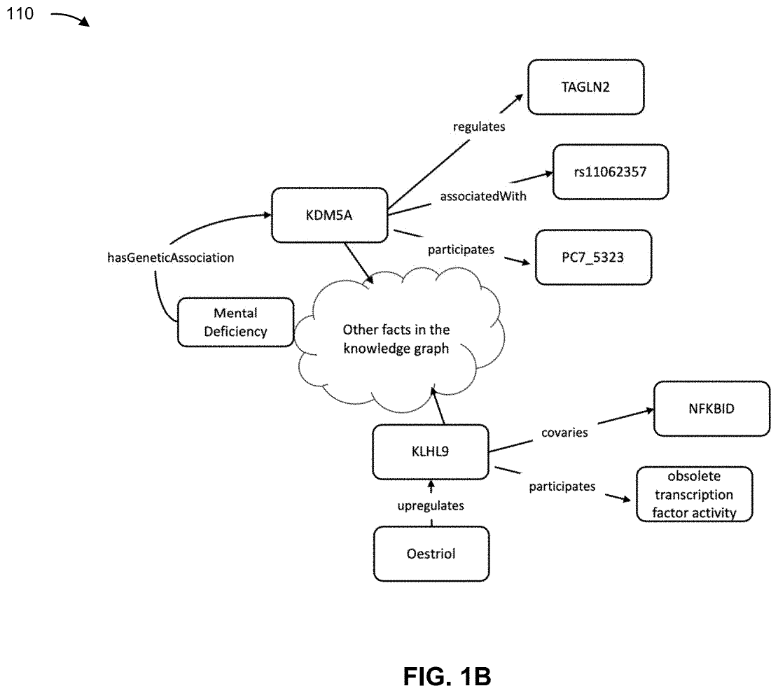

FIGS. 1A-1B are diagrams of an example knowledge graph schema 100 and an example portion of a knowledge graph 110. As shown in FIG. 1A, the knowledge graph schema 100 includes a plurality of nodes and a plurality of links, wherein a link connects two nodes. A link may be a directed link (e.g., the link may be represented as an arrow), such that the link originates from a subject node and terminates at an object node. As further shown in FIG. 1A, each link may have a link type (e.g., a label associated with the link) that indicates a relationship between a subject node and an object node associated with the link.

A knowledge graph schema defines rules for potential links between particular types of nodes that can be used to build a knowledge graph. For example, as shown in FIG. 1A, the knowledge graph schema 100 defines rules for defining relationships between nodes associated with genes, diseases, compounds, pathways, and/or variants, among other examples.

The portion of the knowledge graph 110 shown in FIG. 1B illustrates a portion of a knowledge graph built according to the knowledge graph schema 100. As shown in FIG. 1B, the portion of the knowledge graph 110 shows links associated with “gene” nodes (e.g., KDM5A, KLHL9, NFKBID, and TAGLN2), a “disease” node (e.g., mental deficiency), and/or a “compound” node (e.g., Oestriol), among other examples. In some implementations, the portion of the knowledge graph 110 may be part of an incomplete knowledge graph (e.g., a knowledge graph missing links between nodes), as described herein.

As indicated above, FIGS. 1A-1B are provided as an example. Other examples may differ from what is described with regard to FIGS. 1A-1B.

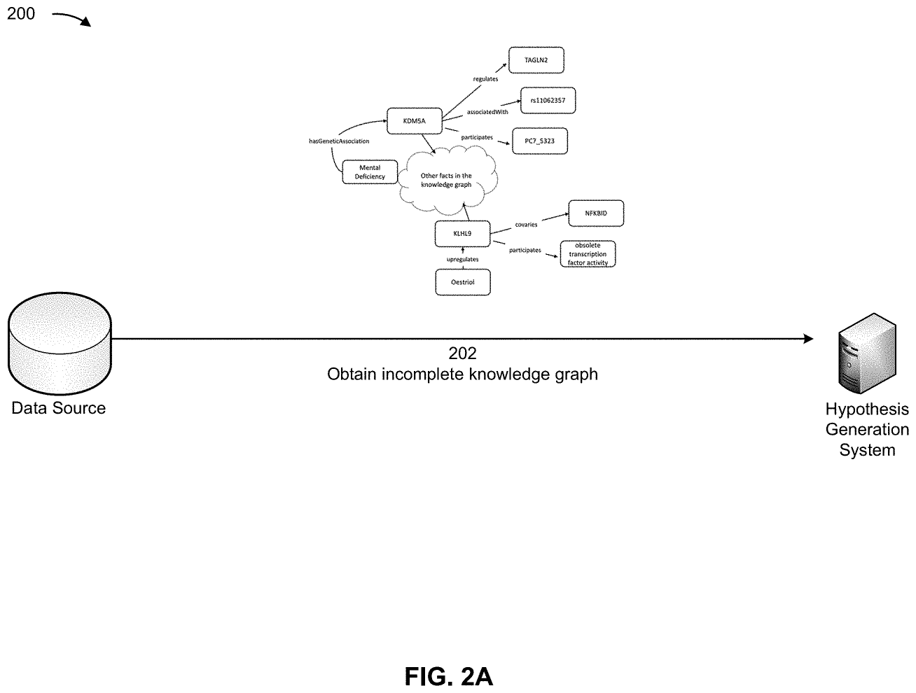

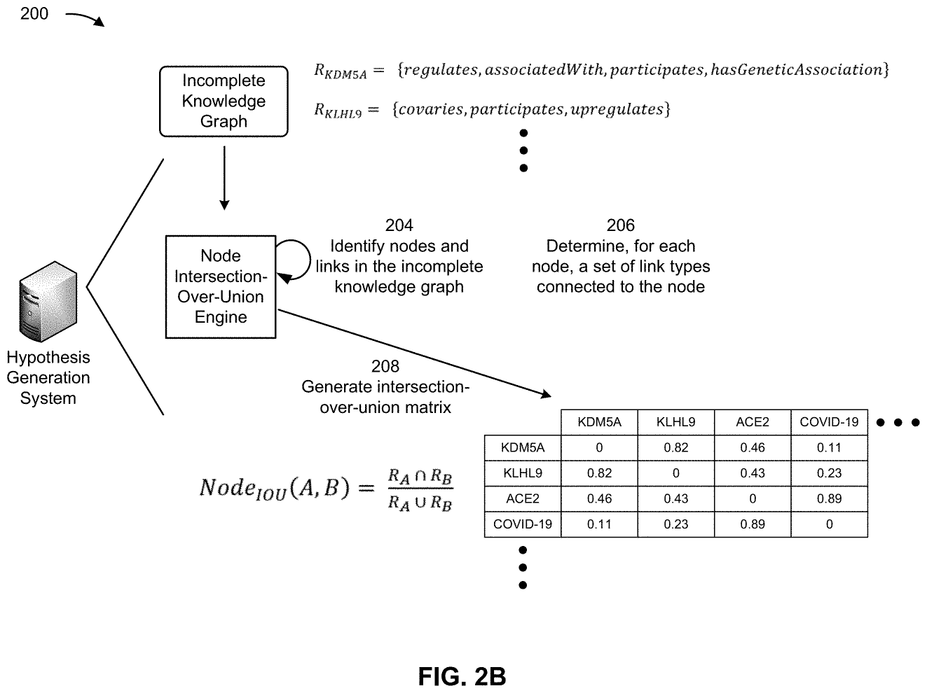

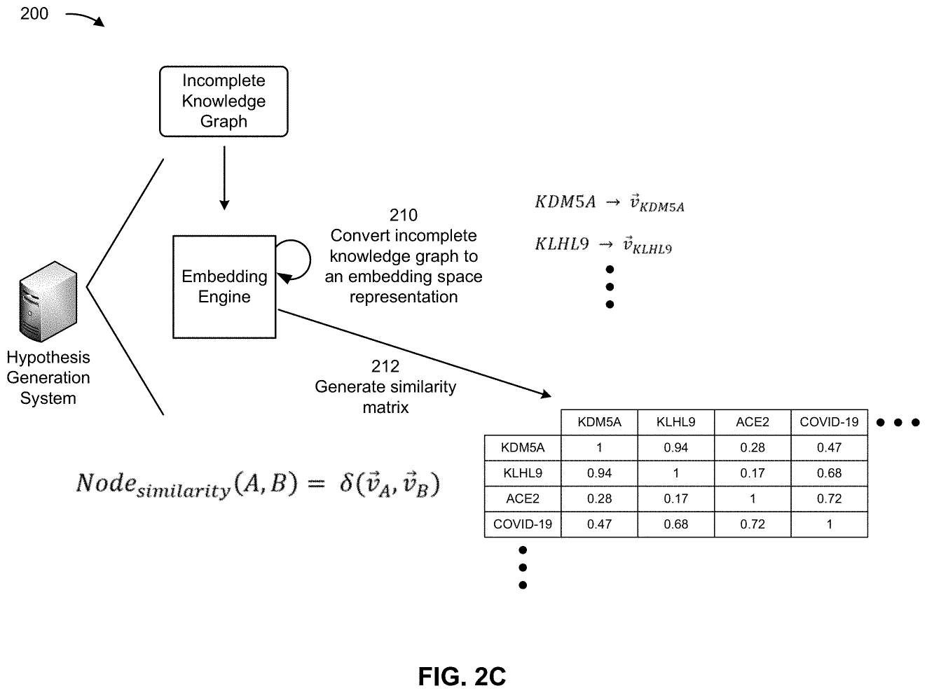

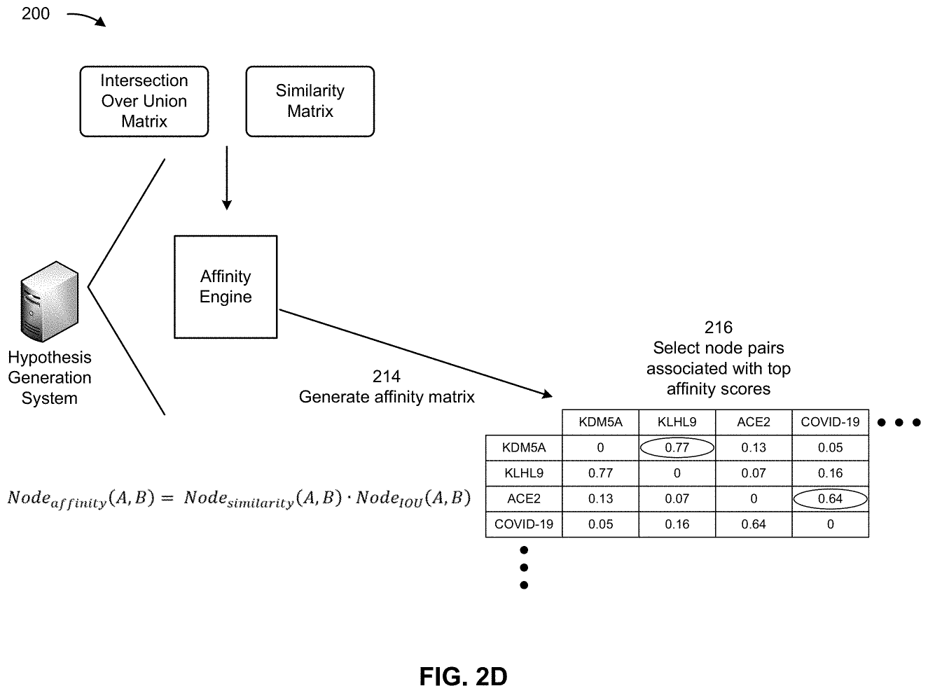

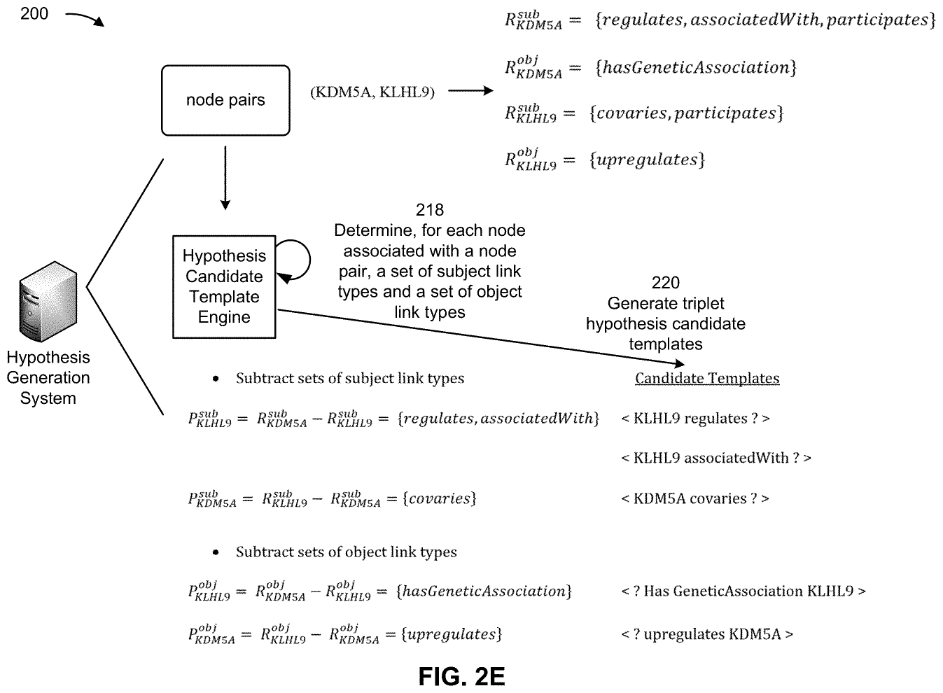

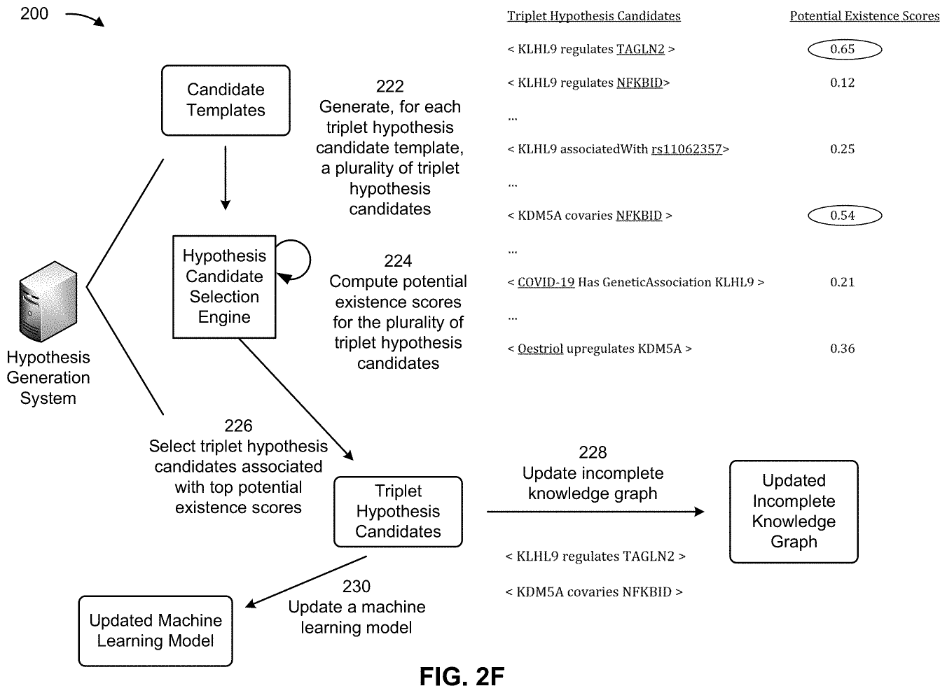

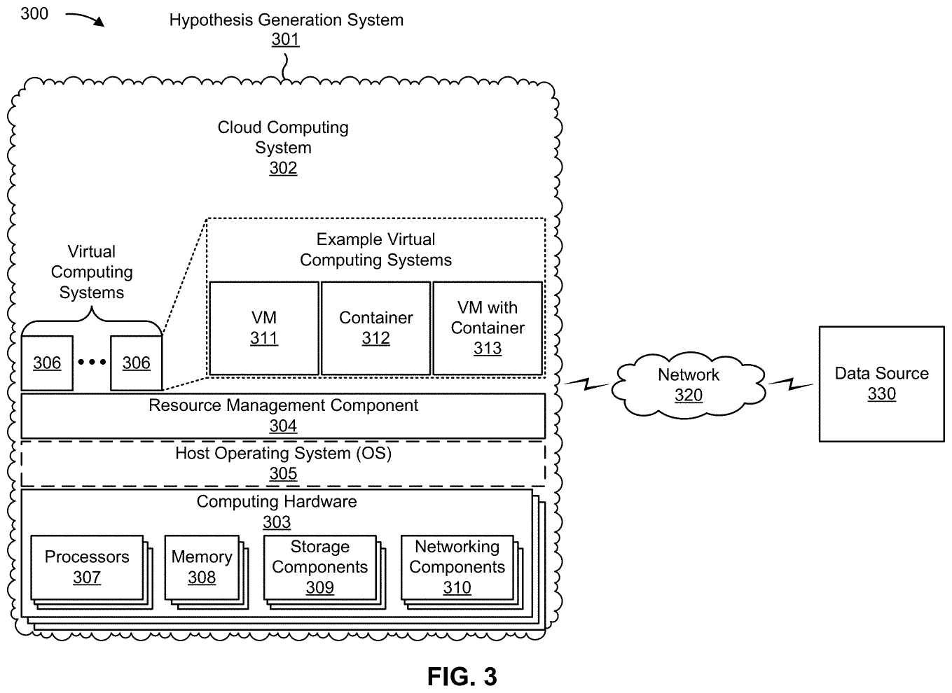

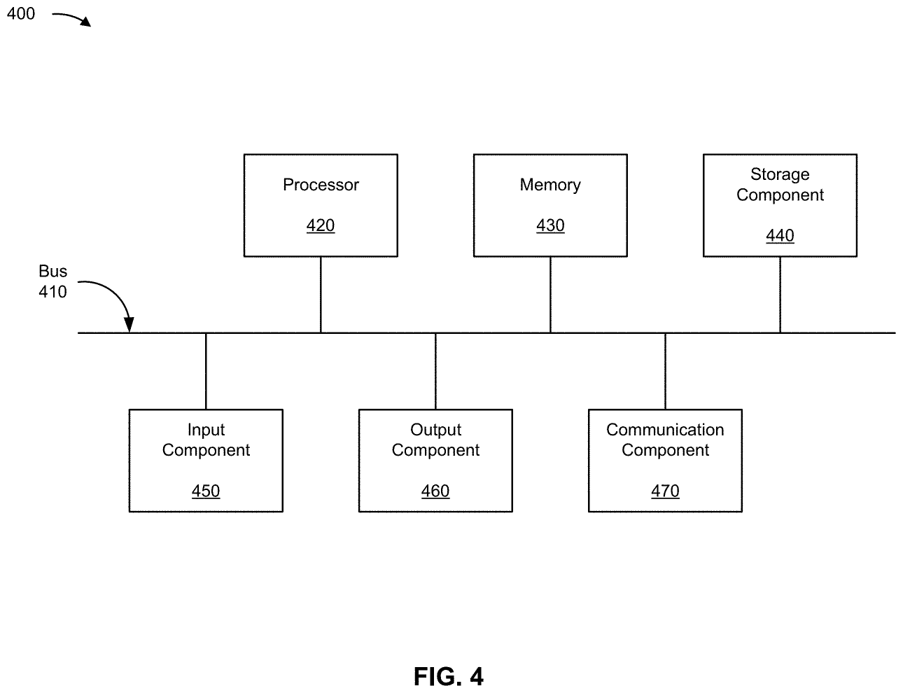

FIGS. 2A-2F are diagrams of an example implementation 200 associated with generating hypothesis candidates associated with an incomplete knowledge graph. As shown in FIG. 2A, example implementation 200 includes a hypothesis generation system and a data source. These devices are described in more detail below in connection with FIG. 3 and FIG. 4.

As shown in FIG. 2A, and by reference number 202, the hypothesis generation system may obtain an incomplete knowledge graph from the data source. As described above, an incomplete knowledge graph may be missing one or more links between different nodes of the incomplete knowledge graph. In some implementations, the hypothesis generation system may send a request to the data source for the incomplete knowledge graph and/or the data source may send the incomplete knowledge graph to the hypothesis generation system.

Turning to FIG. 2B, as shown by reference number 204, the hypothesis generation system may determine and/or identify (e.g., by using a node intersection-over-union engine of the hypothesis generation system) a plurality of nodes and/or a plurality of links of the incomplete knowledge graph. For example, the hypothesis generation system may process the incomplete knowledge graph using a graph traversal technique (e.g., a depth-first graph traversal technique and/or a breadth-first graph traversal technique, among other examples) to identify the plurality of nodes (e.g., names and/or identifiers of the plurality of nodes) and/or the plurality of links (e.g., link types of the plurality of links).

As further shown in FIG. 2B, and by reference number 206, the hypothesis generation system may determine (e.g., by using the node intersection-over-union engine), for each node, of the plurality of nodes, a set of link types connected to the node. For example, when processing the incomplete knowledge graph using the graph traversal technique, the hypothesis generation system may identify a node and identify one or more links connected to the node (e.g., one or more links originating from the node and/or one or more links terminating at the node). The hypothesis generation system may determine respective link types of the one or more links connected to the node and may identify the respective link types as a set of link types for the node. For example, as shown in FIG. 2B, a set of link types (shown as R_{KDM5A}) for a KDM5A node (e.g., of the portion of the knowledge graph 110 shown in FIG. 1B) includes “regulates,” “associatedWith,” “participates,” and “hasGeneticAssociation” link types, and a set of link types (shown as R_{KLHL9}) for a KLHL9 node (e.g., of the portion of the knowledge graph 110) includes “covaries,” “participates,” and “upregulates.”

As further shown in FIG. 2B, and by reference number 208, the hypothesis generation system may generate (e.g., by using the node intersection-over-union engine) an intersection-over-union matrix based on the sets of link types of the plurality of nodes. For example, the hypothesis generation system may identify a first node (shown as A in FIG. 2B) and a second node (shown as B in FIG. 2B), of the plurality of nodes, that form a node pair (shown as (A, B) in FIG. 2B). Accordingly, the hypothesis generation system may compare the set of link types of the first node (shown as R_{A}) and the set of link types of the second node (shown as R_{B}). For example, the hypothesis generation system may determine a common set of link types (shown as R_{A}∩R_{B}) that includes link types shared by the set of link types for the first node and the set of link types for the second node (e.g., an intersection of the set of link types for the first node and the set of link types for the second node). As another example, the hypothesis generation system may determine an overall set of link types (shown as R_{A}∪R_{B}) that includes link types of the set of link types for the first node and the set of link types for the second node (e.g., a union of the set of link types for the first node and the set of link types for the second node).

The hypothesis generation system may determine an intersection-over-union score for the node pair comprising the first node and the second node based on the common set of link types and the overall set of link types. For example, the hypothesis generation system may divide the common set of link types by the overall set of link types (shown as

$$\frac{{R}_{A} ⋂ {R}_{B}}{{R}_{A} ⋃ {R}_{B}}$$

in FIG. 2B) (e.g., divide a number of elements of the common set of link types by a number of elements of the overall set of link types) to determine the intersection-over-union score (shown as Node_{IOU}(A, B) in FIG. 2B). Accordingly, the hypothesis generation system may populate an entry associated with the node pair in the intersection-over-union matrix with the intersection-over-union score.

In this way, the hypothesis generation system may determine a plurality of intersection-over-union scores associated with a plurality of node pairs formed from nodes of the plurality of nodes. Accordingly, the hypothesis generation system may generate the intersection-over-union matrix based on the plurality of intersection-over-union scores (e.g., where at least one entry in the intersection-over-union matrix that is associated with a particular node pair indicates an intersection-over-union score associated with the particular node pair).

Turning to FIG. 2C, and reference number 210, the hypothesis generation system may map, embed, and/or convert (e.g., using an embedding engine of the hypothesis generation system) the incomplete knowledge graph to an embedding space representation. Accordingly, the hypothesis generation system may generate an embedding space representation that includes a plurality of vectors, wherein each vector, of the plurality of vectors, is associated with a node, of the plurality of nodes. For example, as shown in FIG. 2C, the hypothesis generation system may determine a vector \vec{v}_{KDM5A} for a KDM5A node and a vector \vec{v}_{KLHL9} for a KLHL9 node.

In some implementations, to generate the embedding space representation, the hypothesis generation system may process the incomplete knowledge graph using a machine learning model trained to generate the plurality of vectors. For example, the machine learning model may process the incomplete knowledge graph using a scoring function (e.g., a TransE scoring function, a complEx scoring function, and/or a DistMult scoring function, among other examples) and may use an optimizer (e.g., a stochastic gradient descent optimizer) to minimize a loss function (e.g., a pairwise loss function, a negative log likelihood (NLL) function, and/or a multiclass NLL function, among other examples) associated with the scoring function to generate the plurality of vectors.

As further shown in FIG. 2C, and by reference number 212, the hypothesis generation system may generate (e.g., using the embedding engine) a similarity matrix based on the plurality of vectors associated with the embedding space representation. For example, the hypothesis generation system may identify a first node (shown as A in FIG. 2C) and a second node (shown as B in FIG. 2C), of the plurality of nodes, that form a node pair (shown as (A, B) in FIG. 2C). The hypothesis generation system may identify and process a vector associated with the first node (shown as \vec{v}_{A} in FIG. 2C) and a vector associated with the second node (shown as \vec{v}_{B} in FIG. 2C) using a similarity function (shown as δ(\vec{v}_{A}, \vec{v}_{B}) in FIG. 2C) to determine a similarity score for the node pair (shown as Node_{similarity}(A,B) in FIG. 2C). Accordingly, the hypothesis generation system may populate an entry associated with the node pair in the similarity matrix with the similarity score.

In this way, the hypothesis generation system may determine a plurality of similarity scores associated with a plurality of node pairs formed from nodes of the plurality of nodes. Accordingly, the hypothesis generation system may generate the similarity matrix based on the plurality of similarity scores (e.g., where at least one entry in the similarity matrix that is associated with a particular node pair indicates a similarity score associated with the particular node pair).

Turning to FIG. 2D, and reference number 214, the hypothesis generation system may generate (e.g., using an affinity engine of the hypothesis generation system) an affinity matrix based on the intersection-over-union matrix and the similarity matrix. For example, the hypothesis generation system may identify a first node (shown as A in FIG. 2D) and a second node (shown as B in FIG. 2D), of the plurality of nodes, that form a node pair (shown as (A, B) in FIG. 2D). The hypothesis generation system may identify an intersection-over-union matrix score (shown as Node_{IOU}(A, B) in FIG. 2D) associated with the node pair. For example, the hypothesis generation system may search the intersection-over-union matrix for an entry associated with the node pair that indicates the intersection-over-union score. The hypothesis generation system may identify a similarity score (shown as Node_{similarity}(A, B) in FIG. 2D) associated with the node pair. For example, the hypothesis generation system may search the similarity matrix for an entry associated with the node pair that indicates the similarity score. The hypothesis generation system may process the intersection-over-union score and the similarity score to determine an affinity score for the node pair (shown as Node_{affinity}(A, B) in FIG. 2D). For example, for a node pair comprising node KDM5A and node KLHL9, the hypothesis generation system may multiply the intersection-over-union score and the similarity score (0.82·0.94) for the node pair to determine an affinity score (0.77) for the node pair. Accordingly, the hypothesis generation system may populate an entry associated with the node pair in the affinity matrix with the affinity score.

In this way, the hypothesis generation system may determine a plurality of affinity scores associated with a plurality of node pairs from the plurality of nodes. Accordingly, the hypothesis generation system may generate the affinity matrix based on the plurality of affinity scores (e.g., where at least one entry in the affinity matrix that is associated with a particular node pair indicates an affinity score associated with the particular node pair).

As further shown in FIG. 2D, the hypothesis generation system may select and/or identify (e.g., using the affinity engine) node pairs that are associated with top affinity scores. For example, the hypothesis generation system may identify a set of affinity scores (e.g., where the set includes a particular number of affinity scores), of the plurality of affinity scores, that have respective values that are greater than respective values of other affinity scores, of the plurality of affinity scores. Accordingly, the hypothesis generation system may identify and/or select node pairs that are associated with the set of affinity scores.

As another example, the hypothesis generation system may determine whether an affinity score associated with an entry of the affinity matrix satisfies (e.g., is greater than or equal to) an affinity score threshold. When the hypothesis generation system determines that the affinity score satisfies the affinity score threshold, the hypothesis generation system may identify and/or select a node pair associated with the entry. In this way, the hypothesis generation system may identify and/or select one or more node pairs that are respectively associated with one or more affinity scores that satisfy the affinity score threshold. For example, as shown in FIG. 2D, when the affinity score threshold is 0.6, the hypothesis generation system may identify and/or select the (KDM5A, KLHL9) node pair because it has an affinity score of 0.77 that satisfies the affinity score threshold, and the (ACE2, COVID-19) node pair because it has an affinity score of 0.64 that satisfies the affinity score threshold.

Turning to FIG. 2E, and reference number 218, the hypothesis generation system may determine (e.g., using a hypothesis candidate template engine), for each node of a node pair (e.g., that was identified and selected by the hypothesis generation system as described herein in relation to FIG. 2D and reference number 216), a set of subject link types and set of object link types associated with the node. For example, the hypothesis generation system may identify one or more links originating from the node and/or one or more links terminating at the node. The hypothesis generation system may identify and/or determine respective link types of the one or more links originating from the node and may identify the respective link types as a set of subject link types for the node. Additionally, or alternatively, the hypothesis generation system may identify and/or determine respective link types of the one or more links terminating at the node and may identify the respective link types as a set of object link types for the node.

For example, as shown in FIG. 2E, the hypothesis generation system may determine, for a (KDM5A, KLHL9) node pair, that the KDM5A node is associated with a first set of subject link types (shown as R_{KDM5A}^{sub}={regulates, associatedWith, participates}) and a first set of object link types (shown as R_{KDM5A}^{obj}={hasGeneticAssociation}) and that the KLHL9 node is associated with a second set of subject link types (shown as R_{KLHL9}^{sub}={covaries,participates}) and a second set of object link types (shown as R_{KLHL9}^{obj}={upregulates}).

As further shown in FIG. 2E, and by reference number 220, the hypothesis generation system may generate (e.g., using the hypothesis candidate template engine) one or more triplet hypothesis candidate templates. A triplet hypothesis candidate template may be a subject-type triplet hypothesis candidate template or an object-type triplet hypothesis candidate template. A subject-type triplet hypothesis candidate template may identify a subject node, a wildcard (e.g., a “?”) as a placeholder for an object node, and a particular link type. An object-type triplet hypothesis candidate template may include a wildcard as a placeholder for a subject node, an object node, and a particular link type. For example, as shown in FIG. 2E, subject-type triplet hypothesis candidate templates may include <KLHL9 regulates ?>, <KLHL9 associatedWith ?>, and <KDM5A covaries ?>, and object-type triplet hypothesis candidate templates may include <? Has GeneticAssociation KLHL9> and <? upregulates KDM5A>.

In some implementations, the hypothesis generation system may generate one or more triplet hypothesis candidate templates based on a node pair (e.g., of the one or more node pairs). When the node pair includes a first node and a second node, the hypothesis generation system may compare a set of subject link types for the first node and a set of subject link types for the second node to determine a reduced set of subject link types associated with the first node and/or a reduced set of subject link types associated with the second node. For example, for the (KDM5A, KLHL9) node pair shown in FIG. 2E, the hypothesis generation system may subtract a set of subject link types for the KLHL9 node (shown as R_{KLHL9}^{sub} in FIG. 2E) from a set of subject link types for the KDM5A node (shown as R_{KDM5A}^{sub} in FIG. 2E) to determine a reduced set of subject link types associated with the KLHL9 node (shown as P_{KLHL9}^{sub} in FIG. 2E) and/or may subtract the set of subject link types for the KDM5A node from the set of subject link types for the KLHL9 node to determine a reduced set of subject link types associated with the KDM5A node (shown as P_{KDM5A}^{sub} in FIG. 2E).

Additionally, or alternatively, the hypothesis generation system may compare a set of object link types for the first node and a set of object link types for the second node to determine a reduced set of object link types associated with the first node and/or a reduced set of object link types associated with the second node. For example, the hypothesis generation system may subtract a set of object link types for the KLHL9 node (shown as R_{KLHL9}^{obj} in FIG. 2E) from a set of object link types for the KDM5A node (shown as R_{KDM5A}^{obj} in FIG. 2E) to determine a reduced set of object link types associated with the KLHL9 node (shown as P_{KLHL9}^{obj} in FIG. 2E), and/or may subtract the set of object link types for the KDM5A node from the set of object link types for the KLHL9 node to determine a reduced set of object link types associated with the KDM5A node (shown as P_{KDM5A}^{obj} in FIG. 2E).

The hypothesis generation system may generate a triplet hypothesis candidate for each link type identified in the reduced set of subject link types associated with the first node, the reduced set of subject link types associated with the second node, the reduced set of object link types associated with the first node, and/or the reduced set of object link types associated with the first node. For example, as shown in FIG. 2E, when the reduced set of subject link types associated with the KLHL9 node comprises {regulates, associatedWith}, the hypothesis generation system may generate <KLHL9 regulates ?> and <KLHL9 associatedWith ?> subject-type triplet hypothesis candidate templates. As another example, as shown in FIG. 2E, when the reduced set of object link types associated with the KLHL9 node comprises {upregulates}, the hypothesis generation system may generate a <? Has GeneticAssociation KLHL9> object-type triplet hypothesis candidate template. In this way, the hypothesis generation system may generate, for a node pair, one or more subject-type triplet hypothesis candidate templates and/or one or more object-type triplet hypothesis candidate templates.

Turning to FIG. 2F, and reference number 222, the hypothesis generation system may generate (e.g., using a hypothesis candidate selection engine), for a triplet hypothesis candidate template, a plurality of triplet hypothesis candidates. A triplet hypothesis candidate may identify a first particular node as a subject node, a second particular node as an object node, and a link type associated with the first particular node and the second particular node. In some implementations, the hypothesis generation system may replace the wildcard in the triplet hypothesis candidate template with a node (e.g., a “hypothesis node”), of the plurality of nodes, to generate a triplet hypothesis candidate. The hypothesis generation system may repeatedly replace the wildcard in the triplet hypothesis candidate with different hypothesis nodes, of the plurality of nodes, to generate a plurality of triplet hypothesis candidates. For example, as shown in FIG. 2F, the hypothesis generation system may replace the wildcard in the <KLHL9 regulates ?> triplet hypothesis candidate template with other nodes (e.g., from the portion of the knowledge graph 110 shown in FIG. 1B) to form triplet hypothesis candidates <KLHL9 regulates TAGLN2> and <KLHL9 regulates NFKBID>. The hypothesis nodes may include some or all of the plurality of nodes.

As further shown in FIG. 2F, and by reference number 224, the hypothesis generation system may compute (e.g., using the hypothesis candidate selection engine) potential existence scores for the plurality of triplet hypothesis candidates (e.g., that were generated by the hypothesis generation system). A potential existence score may indicate a likelihood that an associated triplet hypothesis candidate is correct (e.g., a likelihood that a link, with a link type indicated by the triplet hypothesis candidate, is missing in the incomplete knowledge graph between the object node and the subject node indicated by the triplet hypothesis candidate). In some implementations, the hypothesis generation system may process the plurality of triplet hypothesis candidates using a machine learning model (e.g., the same machine learning model as described herein in relation to FIG. 2C and reference number 210, or a different machine learning model) to generate the respective potential existence scores associated with the plurality of triplet hypothesis candidates. For example, the machine learning model may use a scoring function (e.g., a TransE scoring function, a complEx scoring function, and/or a DistMult scoring function, among other examples) of the machine learning model to generate the respective potential existence scores associated with the plurality of triplet hypothesis candidates.

As further shown in FIG. 2F, and by reference number 226, the hypothesis generation system may select and/or identify (e.g., using the hypothesis candidate selection engine) triplet hypothesis candidates associated with top potential existence scores. For example, the hypothesis generation system may identify a set of potential existence scores (e.g., where the set includes a particular number of potential existence scores), of the plurality of potential existence scores, that have respective values that are greater than respective values of other potential existence scores, of the plurality of potential existence scores. Accordingly, the hypothesis generation system may identify and/or select triplet hypothesis candidates that are associated with the set of potential existence scores.

As another example, the hypothesis generation system may determine whether a potential existence score associated with a triplet hypothesis candidate satisfies (e.g., is greater than or equal to) a potential existence score threshold. When the hypothesis generation system determines that the potential existence score satisfies the potential existence score threshold, the hypothesis generation system may identify and/or select the triplet hypothesis candidate associated with the potential existence score. In this way, the hypothesis generation system may identify and/or select one or more triplet hypothesis candidates that are respectively associated with one or more potential existence scores that satisfy the potential existence score threshold. For example, as shown in FIG. 2F, when the potential existence score threshold is 0.5, the hypothesis generation system may identify and/or select the <KLHL9 regulates TAGLN2> triplet hypothesis candidate because it has a potential existence score of 0.65 that satisfies the potential existence score threshold, and select the <KDM5A covaries NFKBID> triplet hypothesis candidate because it has a potential existence score of 0.54 that satisfies the potential existence score threshold.

As further shown in FIG. 2F, the hypothesis generation system may cause one or more actions to be performed (e.g., based on the one or more triplet hypothesis candidates identified and/or selected by the hypothesis generation system). As shown by reference number 228, the one or more actions may include updating the incomplete knowledge graph. For example, for a triplet hypothesis candidate, of the one or more triplet hypothesis candidates, the hypothesis generation system may identify a subject node, an object node, and a link type identifier included in the triplet hypothesis candidate. Accordingly, the hypothesis generation system may cause a link to be added to the incomplete knowledge graph, where the link originates from the subject node, terminates at the object node, and has a link type indicated by the link type identifier.

As shown by reference number 230, the one or more actions may include updating a machine learning model. For example, the hypothesis generation system may identify a machine learning model (e.g., one of the machine learning models described above or a different machine learning model), such as a machine learning model trained to identify missing links in incomplete knowledge graphs or a machine learning model trained to predict triplet hypothesis candidates. Accordingly, the hypothesis generation system may update and/or retrain the machine learning model using the one or more triplet hypothesis candidates or may provide the triplet hypothesis candidates (e.g., to another device) to cause the machine learning model to be updated and/or retrained.

As indicated above, FIGS. 2A-2F are provided as an example. Other examples may differ from what is described with regard to FIGS. 2A-2F. The number and arrangement of devices shown in FIGS. 2A-2F are provided as an example. In practice, there may be additional devices, fewer devices, different devices, or differently arranged devices than those shown in FIGS. 2A-2F. Furthermore, two or more devices shown in FIGS. 2A-2F may be implemented within a single device, or a single device shown in FIGS. 2A-2F may be implemented as multiple, distributed devices. Additionally, or alternatively, a set of devices (e.g., one or more devices) shown in FIGS. 2A-2F may perform one or more functions described as being performed by another set of devices shown in FIGS. 2A-2F.

FIG. 3 is a diagram of an example environment 300 in which systems and/or methods described herein may be implemented. As shown in FIG. 3, environment 300 may include a hypothesis generation system 301, which may include one or more elements of and/or may execute within a cloud computing system 302. The cloud computing system 302 may include one or more elements 303-313, as described in more detail below. As further shown in FIG. 3, environment 300 may include a network 320 and/or a data source 330. Devices and/or elements of environment 300 may interconnect via wired connections and/or wireless connections.

The cloud computing system 302 includes computing hardware 303, a resource management component 304, a host operating system (OS) 305, and/or one or more virtual computing systems 306. The resource management component 304 may perform virtualization (e.g., abstraction) of computing hardware 303 to create the one or more virtual computing systems 306. Using virtualization, the resource management component 304 enables a single computing device (e.g., a computer, a server, and/or the like) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

Computing hardware 303 includes hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, and/or the like) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using computing hardware 303. As shown, a virtual computing system 306 may include a virtual machine 311, a container 312, a hybrid environment 313 that includes a virtual machine and a container, and/or the like. A virtual computing system 306 may execute one or more applications using a file system that includes binary files, software libraries, and/or other resources required to execute applications on a guest operating system (e.g., within the virtual computing system 306) or the host operating system 305.

Although the hypothesis generation system 301 may include one or more elements 303-313 of the cloud computing system 302, may execute within the cloud computing system 302, and/or may be hosted within the cloud computing system 302, in some implementations, the hypothesis generation system 301 may not be cloud-based (e.g., may be implemented outside of a cloud computing system) or may be partially cloud-based. For example, the hypothesis generation system 301 may include one or more devices that are not part of the cloud computing system 302, such as device 400 of FIG. 4, which may include a standalone server or another type of computing device. The hypothesis generation system 301 may perform one or more operations and/or processes described in more detail elsewhere herein.

Network 320 includes one or more wired and/or wireless networks. For example, network 320 may include a cellular network, a public land mobile network (PLMN), a local area network (LAN), a wide area network (WAN), a private network, the Internet, and/or the like, and/or a combination of these or other types of networks. The network 320 enables communication among the devices of environment 300.

The data source 330 includes one or more devices capable of receiving, generating, storing, processing, and/or providing information associated with an incomplete knowledge graph, as described elsewhere herein. The data source 330 may include a communication device and/or a computing device. For example, the data source 330 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data source 330 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400, which may correspond to hypothesis generation system 301, computing hardware 303, and/or data source 330. In some implementations, hypothesis generation system 301, computing hardware 303, and/or data source 330 may include one or more devices 400 and/or one or more components of device 400. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may store a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

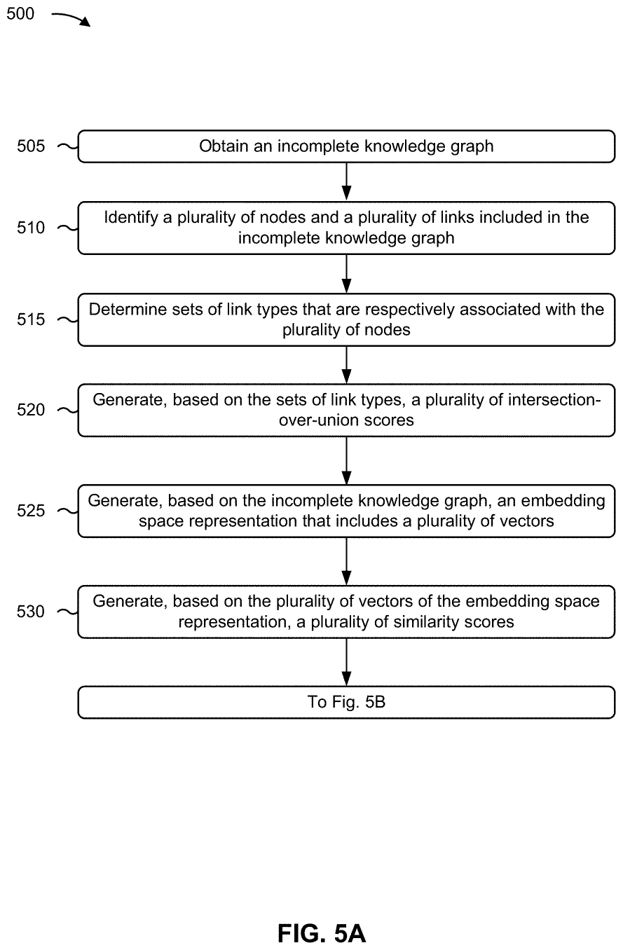

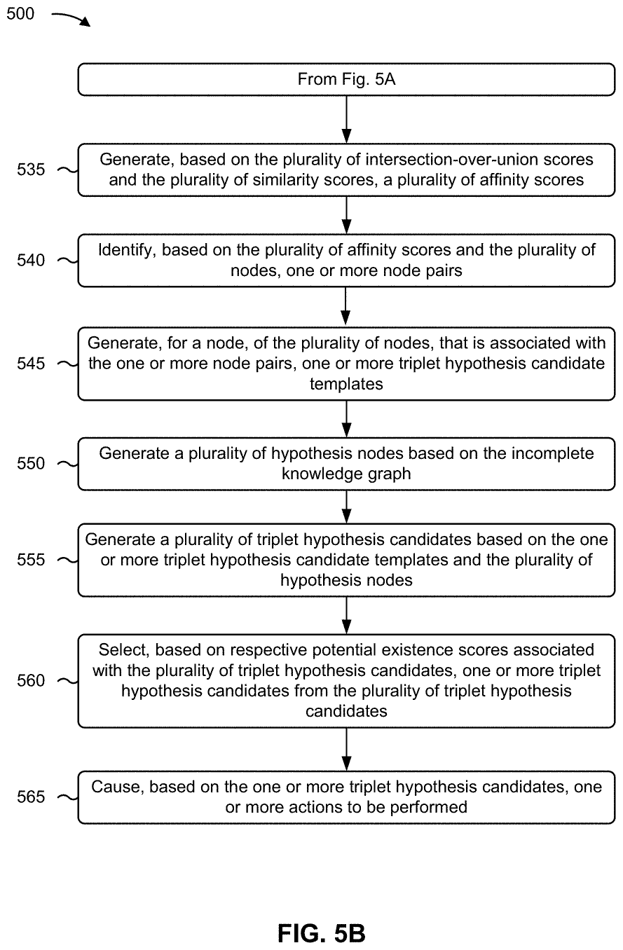

FIGS. 5A-5B depict a flowchart of an example process 500 associated with generating hypothesis candidates associated with an incomplete knowledge graph. In some implementations, one or more process blocks of FIGS. 5A-5B may be performed by a device (e.g., hypothesis generation system 301). In some implementations, one or more process blocks of FIGS. 5A-5B may be performed by another device or a group of devices separate from or including the device, such as data source 330). Additionally, or alternatively, one or more process blocks of FIGS. 5A-5B may be performed by one or more components of device 400, such as processor 420, memory 430, storage component 440, input component 450, output component 460, and/or communication component 470.

As shown in FIG. 5A, process 500 may include obtaining an incomplete knowledge graph (block 505). For example, the device may obtain an incomplete knowledge graph, as described above.

As further shown in FIG. 5A, process 500 may include identifying a plurality of nodes and a plurality of links included in the incomplete knowledge graph (block 510). For example, the device may identify a plurality of nodes and a plurality of links included in the incomplete knowledge graph, as described above. In some implementations, each link, of the plurality of links, is associated with a link type and connects two different nodes of the plurality of nodes.

As further shown in FIG. 5A, process 500 may include determining sets of link types that are respectively associated with the plurality of nodes (block 515). For example, the device may determine sets of link types that are respectively associated with the plurality of nodes, as described above.

As further shown in FIG. 5A, process 500 may include generating, based on the sets of link types, a plurality of intersection-over-union scores (block 520). For example, the device may generate, based on the sets of link types, a plurality of intersection-over-union scores, as described above. In some implementations, the device may generate, based on the sets of link types, an intersection-over-union matrix that includes the plurality of intersection-over-union scores.

As further shown in FIG. 5A, process 500 may include generating, based on the incomplete knowledge graph, an embedding space representation that includes a plurality of vectors (block 525). For example, the device may generate, based on the incomplete knowledge graph, an embedding space representation that includes a plurality of vectors, as described above. In some implementations, the plurality of vectors are respectively associated with the plurality of nodes.

As further shown in FIG. 5A, process 500 may include generating, based on the plurality of vectors of the embedding space representation, a plurality of similarity scores (block 530). For example, the device may generate, based on the plurality of vectors of the embedding space representation, a plurality of similarity scores, as described above. In some implementations, the device may generate, based on the plurality of vectors of the embedding space representation, a similarity matrix that includes the plurality of similarity scores.

As shown in FIG. 5B, process 500 may include generating, based on the plurality of intersection-over-union scores and the plurality of similarity scores, a plurality of affinity scores (block 535). For example, the device may generate, based on the plurality of intersection-over-union scores and the plurality of similarity scores, a plurality of affinity scores, as described above. In some implementations, the device may generate, based on the intersection-over-union matrix and the similarity matrix, an affinity matrix. The affinity matrix may include the plurality of affinity scores.

As further shown in FIG. 5B, process 500 may include identifying, based on the plurality of affinity scores and the plurality of nodes, one or more node pairs (block 540). For example, the device may identify, based on the plurality of affinity scores and the plurality of nodes, one or more node pairs, as described above. In some implementations, the device may identify, based on the affinity matrix and the plurality of nodes, the one or more node pairs.

As further shown in FIG. 5B, process 500 may include generating, for a node, of the plurality of nodes, that is associated with the one or more node pairs, one or more triplet hypothesis candidate templates (block 545). For example, the device may generate, for a node, of the plurality of nodes, that is associated with the one or more node pairs, one or more triplet hypothesis candidate templates, as described above.

As further shown in FIG. 5B, process 500 may include generating a plurality of hypothesis nodes based on the incomplete knowledge graph (block 550). For example, the device may generate a plurality of hypothesis nodes based on the incomplete knowledge graph, as described above.

As further shown in FIG. 5B, process 500 may include generating a plurality of triplet hypothesis candidates based on the one or more triplet hypothesis candidate templates and the plurality of hypothesis nodes (block 555). For example, the device may generate a plurality of triplet hypothesis candidates based on the one or more triplet hypothesis candidate templates and the plurality of hypothesis nodes, as described above.

As further shown in FIG. 5B, process 500 may include selecting, based on respective potential existence scores associated with the plurality of triplet hypothesis candidates, one or more triplet hypothesis candidates from the plurality of triplet hypothesis candidates (block 560). For example, the device may select, based on respective potential existence scores associated with the plurality of triplet hypothesis candidates, one or more triplet hypothesis candidates from the plurality of triplet hypothesis candidates, as described above.

As further shown in FIG. 5B, process 500 may include causing, based on the one or more triplet hypothesis candidates, one or more actions to be performed (block 565). For example, the device may cause, based on the one or more triplet hypothesis candidates, one or more actions to be performed, as described above.

In some implementations, a triplet hypothesis candidate, of the one or more triplet hypothesis candidates, identifies a first particular node, of the plurality of nodes, as a subject node, identifies a second particular node, of the plurality of nodes, as an object node, and identifies a particular link type associated with the first particular node and the second particular node.

In some implementations, causing the one or more actions to be performed comprises identifying a machine learning model trained to identify missing links in incomplete knowledge graphs and causing the machine learning model to be updated based on the one or more triplet hypothesis candidates.

In some implementations, determining the sets of link types comprises identifying a node, of the plurality of nodes, identifying one or more links connected to the node, determining respective link types associated with the one or more links, and identifying the respective link types as a set of link types for the node.

In some implementations, generating the intersection-over-union matrix comprises identifying a first node and a second node of the plurality of nodes, determining a common set of link types that includes link types shared by a set of link types associated with the first node and a set of link types associated with the second node, determining an overall set of link types that includes link types of the set of link types associated with the first node and the set of link types associated with the second node, determining an intersection-over-union score based on the common set of link types and the overall set of link types, and populating, with the intersection-over-union score, an entry of the intersection-over-union matrix that is associated with the first node and the second node. In some implementations, the intersection-over-union matrix comprises a plurality of intersection-over-union scores associated with a plurality of node pairs formed from nodes of the plurality of nodes.

In some implementations, generating the similarity matrix comprises identifying a first vector associated with a first particular node and a second vector associated with a second particular node of the plurality of nodes, processing, using a vector similarity function, the first vector and the second vector to determine a similarity score, and populating, with the similarity score, an entry of the similarity matrix that is associated with the first particular node and the second particular node.

In some implementations, generating the affinity matrix comprises identifying, based on the intersection-over-union matrix, an intersection-over-union score associated with a first particular node and a second particular node of the plurality of nodes, identifying, based on the similarity matrix, a similarity score associated with the first particular node and the second particular node, determining an affinity score based on the intersection-over-union score and the similarity score, and populating, with the affinity score, an entry of the affinity matrix that is associated with the first particular node and the second particular node.

In some implementations, identifying the one or more node pairs comprises identifying an affinity score associated with an entry of the affinity matrix, determining that the affinity score satisfies an affinity score threshold, identifying, based on determining that the affinity score satisfies the affinity score threshold, a first particular node and a second particular node associated with the entry of the affinity matrix, and identifying the first particular node and the second particular node as comprising a particular node pair of the one or more node pairs.

In some implementations, generating the one or more triplet hypothesis candidate templates comprises identifying, for a first particular node, a first set of link types associated with the first particular node, identifying, for a second particular node, a second set of link types associated with the second particular node, determining, based on the first set of link types and the second set of link types, a reduced set of link types, and generating the one or more triplet hypothesis candidate templates based on the reduced set of link types.

In some implementations, process 500 includes processing, using a machine learning model, the plurality of triplet hypothesis candidates to generate the respective potential existence scores associated with the plurality of triplet hypothesis candidates.

In some implementations, selecting the one or more triplet hypothesis candidates comprises identifying a potential existence score associated with a triplet hypothesis candidate, of the one or more triplet hypothesis candidates, determining that the potential existence score satisfies a potential existence score threshold, and causing the triplet hypothesis candidate to be identified as included in the one or more triplet hypothesis candidates.

In some implementations, causing the one or more actions to be performed includes identifying a triplet hypothesis candidate, of the one or more triplet hypothesis candidates, identifying a subject node of the triplet hypothesis candidate, identifying an object node of the triplet hypothesis candidate, identifying a link type identifier of the triplet hypothesis candidate, and causing a link to be added to the incomplete knowledge graph based on the subject node, the object node, and the link type identifier.

In some implementations, determining the plurality of intersection-over-union scores includes identifying a first node and a second node of the plurality of nodes, determining a common set of link types that includes link types shared by a set of link types associated with the first node and a set of link types associated with the second node, determining an overall set of link types that includes link types of the set of link types associated with the first node and the set of link types associated with the second node, and determining an intersection-over-union score associated with the first node and the second node based on the common set of link types and the overall set of link types.

In some implementations, determining the plurality of affinity scores includes identifying an intersection-over-union score, of the plurality of intersection-over-union scores, associated with a first node and a second node of the plurality of nodes, identifying a similarity score, of the plurality of similarity scores, associated with the first node and the second node, and determining an affinity score associated with the first node and the second node based on the intersection-over-union score and the similarity score.

In some implementations, identifying the one or more node pairs includes identifying a particular affinity score, of the plurality of affinity scores, that has a value that is greater than respective values of a threshold number of affinity scores of the plurality of affinity scores, identifying, based on identifying the particular affinity score, a first node and a second node associated with the particular affinity score, and identifying the first node and the second node as comprising a particular node pair of the one or more node pairs.

In some implementations, causing the one or more actions to be performed includes causing, based on the plurality of triplet hypothesis candidates, at least one of the incomplete knowledge graph to be updated, or a machine learning model trained to predict triplet hypothesis candidates to be updated.

In some implementations, generating the one or more triplet hypothesis candidate templates includes identifying, for a first node of the node pair, a first set of first link types associated with the first node and a first set of second link types associated with the first node; identifying, for a second node of the node pair, a second set of first link types associated with the second node and a second set of second link types associated with the second node; determining, based on the first set of first link types and the second set of first link types, a first reduced set of first link types and a second reduced set of first link types; determining, based on the first set of second link types and the second set of second link types, a first reduced set of second link types and a second reduced set of second link types; and generating a triplet hypothesis candidate template, of the one or more triplet hypothesis candidate templates, based on the first reduced set of first link types, the second reduced set of first link types, the first reduced set of second link types, and the second reduced set of second link types.

In some implementations, process 500 includes generating an intersection-over-union matrix based on the plurality of intersection-over-union scores, generating a similarity matrix based on the plurality of similarity scores, and generating an affinity matrix based on the plurality of affinity scores.

Although FIGS. 5A-5B show example blocks of process 500, in some implementations, process 500 may include additional blocks, fewer blocks, different blocks, or differently arranged blocks than those depicted in FIGS. 5A-5B. Additionally, or alternatively, two or more of the blocks of process 500 may be performed in parallel.

The foregoing disclosure provides illustration and description, but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, etc., depending on the context.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
obtaining an incomplete knowledge graph,
wherein the incomplete knowledge graph includes a plurality of nodes and a plurality of links,
wherein each link, of the plurality of links, is associated with a link type and connects two different nodes of the plurality of nodes;
determining sets of link types that are respectively associated with the plurality of nodes;
identifying a first node and a second node of the plurality of nodes;
determining a common set of link types that includes link types shared by a set of link types associated with the first node and a set of link types associated with the second node;
determining an overall set of link types that includes link types of the set of link types associated with the first node and the set of link types associated with the second node;
determining an intersection-over-union score based on the common set of link types and the overall set of link types;
populating, with the intersection-over-union score, an entry of an intersection-over-union matrix that is associated with the first node and the second node;
generating, based on the incomplete knowledge graph, an embedding space representation that includes a plurality of vectors,
wherein the plurality of vectors are respectively associated with the plurality of nodes;
generating, based on the plurality of vectors of the embedding space representation, a similarity matrix;
generating, based on the intersection-over-union matrix and the similarity matrix, an affinity matrix;
identifying, based on the affinity matrix and the plurality of nodes, one or more node pairs;
generating, for a node, of the plurality of nodes, that is associated with the one or more node pairs, one or more triplet hypothesis candidate templates;
generating a plurality of hypothesis nodes based on the incomplete knowledge graph;
generating a plurality of triplet hypothesis candidates based on the one or more triplet hypothesis candidate templates and the plurality of hypothesis nodes;
selecting, based on respective potential existence scores associated with the plurality of triplet hypothesis candidates, one or more triplet hypothesis candidates from the plurality of triplet hypothesis candidates; and
causing, based on the one or more triplet hypothesis candidates, one or more actions to be performed.

2. The method of claim 1, wherein a triplet hypothesis candidate, of the one or more triplet hypothesis candidates, identifies:
a first particular node, of the plurality of nodes, as a subject node;
a second particular node, of the plurality of nodes, as an object node; and
a particular link type associated with the first particular node and the second particular node.

3. The method of claim 1, wherein causing the one or more actions to be performed comprises:
identifying a machine learning model trained to identify missing links in incomplete knowledge graphs; and
causing the machine learning model to be updated based on the one or more triplet hypothesis candidates.

4. The method of claim 1, wherein determining the sets of link types comprises:
identifying a node, of the plurality of nodes;
identifying one or more links connected to the node;
determining respective link types associated with the one or more links; and
identifying the respective link types as a set of link types for the node.

5. The method of claim 1, wherein the intersection-over-union matrix comprises a plurality of intersection-over-union scores associated with a plurality of node pairs formed from nodes of the plurality of nodes.

6. The method of claim 1, wherein generating the similarity matrix comprises:
identifying a first vector associated with a first particular node and a second vector associated with a second particular node of the plurality of nodes;
processing, using a vector similarity function, the first vector and the second vector to determine a similarity score; and
populating, with the similarity score, an entry of the similarity matrix that is associated with the first particular node and the second particular node.

7. The method of claim 1, wherein generating the affinity matrix comprises:
identifying, based on the intersection-over-union matrix, an intersection-over-union score associated with a first particular node and a second particular node of the plurality of nodes;
identifying, based on the similarity matrix, a similarity score associated with the first particular node and the second particular node;
determining an affinity score based on the intersection-over-union score and the similarity score; and
populating, with the affinity score, an entry of the affinity matrix that is associated with the first particular node and the second particular node.

8. The method of claim 1, wherein identifying the one or more node pairs comprises:
identifying an affinity score associated with an entry of the affinity matrix;
determining that the affinity score satisfies an affinity score threshold;
identifying, based on determining that the affinity score satisfies the affinity score threshold, a first particular node and a second particular node associated with the entry of the affinity matrix; and
identifying the first particular node and the second particular node as comprising a particular node pair of the one or more node pairs.

9. The method of claim 1, wherein generating the one or more triplet hypothesis candidate templates comprises:
identifying, for a first particular node, a first set of link types associated with the first particular node;
identifying, for a second particular node, a second set of link types associated with the second particular node;
determining, based on the first set of link types and the second set of link types, a reduced set of link types; and
generating the one or more triplet hypothesis candidate templates based on the reduced set of link types.

10. The method of claim 1, further comprising, before selecting the one or more triplet hypothesis candidates:
processing, using a machine learning model, the plurality of triplet hypothesis candidates to generate the respective potential existence scores associated with the plurality of triplet hypothesis candidates.

11. The method of claim 1, wherein selecting the one or more triplet hypothesis candidates comprises:
identifying a potential existence score associated with a triplet hypothesis candidate, of the one or more triplet hypothesis candidates;
determining that the potential existence score satisfies a potential existence score threshold; and
causing the triplet hypothesis candidate to be identified as included in the one or more triplet hypothesis candidates.

12. A device, comprising:
one or more memories; and
one or more processors, communicatively coupled to the one or more memories, configured to:
identify a plurality of nodes and a plurality of links included in an incomplete knowledge graph,
determine sets of link types that are respectively associated with the plurality of nodes;
determine, based on the sets of link types, a plurality of intersection-over-union scores;
generate an embedding space representation associated with the incomplete knowledge graph that includes a plurality of vectors associated with the plurality of nodes,
determine, based on the plurality of vectors of the embedding space representation, a plurality of similarity scores;
determine, based on the plurality of intersection-over-union scores and the plurality of similarity scores, a plurality of affinity scores;
identify, based on the plurality of affinity scores and the plurality of nodes, one or more node pairs;
generate, for a node pair, of the one or more node pairs, one or more triplet hypothesis candidate templates;
generate, for a triplet hypothesis candidate template, of the one or more triplet hypothesis candidate templates, a plurality of triplet hypothesis candidates;
identify, based on respective potential existences scores associated with the plurality of triplet hypothesis candidates, one or more triplet hypothesis candidates; and
cause, based on the one or more triplet hypothesis candidates, one or more actions to be performed.

13. The device of claim 12, wherein the one or more processors, when causing the one or more actions to be performed, are configured to:
identify a triplet hypothesis candidate, of the one or more triplet hypothesis candidates;
identify a subject node of the triplet hypothesis candidate;
identify an object node of the triplet hypothesis candidate;
identify a link type identifier of the triplet hypothesis candidate; and
cause a link to be added to the incomplete knowledge graph based on the subject node, the object node, and the link type identifier.

14. The device of claim 12, wherein the one or more processors, when determining the plurality of intersection-over-union scores, are configured to:
identify a first node and a second node of the plurality of nodes;
determine a common set of link types that includes link types shared by a set of link types associated with the first node and a set of link types associated with the second node;
determine an overall set of link types that includes link types of the set of link types associated with the first node and the set of link types associated with the second node; and
determine an intersection-over-union score associated with the first node and the second node based on the common set of link types and the overall set of link types.

15. The device of claim 12, wherein the one or more processors, when determining the plurality of affinity scores, are configured to:
identify an intersection-over-union score, of the plurality of intersection-over-union scores, associated with a first node and a second node of the plurality of nodes;
identify a similarity score, of the plurality of similarity scores, associated with the first node and the second node; and
determine an affinity score associated with the first node and the second node based on the intersection-over-union score and the similarity score.

16. The device of claim 12, wherein the one or more processors, when identifying the one or more node pairs, are configured to:
identify a particular affinity score, of the plurality of affinity scores, that has a value that is greater than respective values of a threshold number of affinity scores of the plurality of affinity scores;
identify, based on identifying the particular affinity score, a first node and a second node associated with the particular affinity score; and
identify the first node and the second node as comprising a particular node pair of the one or more node pairs.

17. A non-transitory computer-readable medium storing a set of instructions, the set of instructions comprising:
one or more instructions that, when executed by one or more processors of a device, cause the device to:
determine sets of link types that are respectively associated with a plurality of nodes included in an incomplete knowledge graph;
determine, based on the sets of link types, a plurality of intersection-over-union scores;
determine, based on a plurality of vectors of an embedding space representation associated with the incomplete knowledge graph, a plurality of similarity scores;
determine, based on the plurality of intersection-over-union scores and the plurality of similarity scores, a plurality of affinity scores;
determine, based on the plurality of affinity scores and the plurality of nodes, one or more node pairs;
generate, for a node pair, of the one or more node pairs, one or more triplet hypothesis candidate templates;
generate, for a triplet hypothesis candidate template, of the one or more triplet hypothesis candidate templates, a plurality of triplet hypothesis candidates; and
cause, based on the plurality of triplet hypothesis candidates, one or more actions to be performed.

18. The non-transitory computer-readable medium of claim 17, wherein the one or more instructions, that cause the device to cause the one or more actions to be performed, cause the device to:
cause, based on the plurality of triplet hypothesis candidates, at least one of:
the incomplete knowledge graph to be updated; or
a machine learning model trained to predict triplet hypothesis candidates to be updated.

19. The non-transitory computer-readable medium of claim 17, wherein the one or more instructions, that cause the device to generate the one or more triplet hypothesis candidate templates for the node pair, cause the device to:
identify, for a first node of the node pair, a first set of first link types associated with the first node and a first set of second link types associated with the first node;
identify, for a second node of the node pair, a second set of first link types associated with the second node and a second set of second link types associated with the second node;
determine, based on the first set of first link types and the second set of first link types, a first reduced set of first link types and a second reduced set of first link types;
determine, based on the first set of second link types and the second set of second link types, a first reduced set of second link types and a second reduced set of second link types; and
generate a triplet hypothesis candidate template, of the one or more triplet hypothesis candidate templates, based on the first reduced set of first link types, the second reduced set of first link types, the first reduced set of second link types, and the second reduced set of second link types.

20. The non-transitory computer-readable medium of claim 17, wherein the one or more instructions, when executed by the one or more processors of the device, further cause the device to:
generate an intersection-over-union matrix based on the plurality of intersection-over-union scores;
generate a similarity matrix based on the plurality of similarity scores; and
generate an affinity matrix based on the plurality of affinity scores.
